(19) United States
(12) Patent Application Publication
(10) Pub. No.: US 2010/0070364 A1
(43) Pub. Date: Mar. 18, 2010

(54) PipPops - Partners In Profit Point Of Purchase Savings System

(76) Inventor: James Michael Dugan, Orlando, FL (US)

Correspondence Address: James Michael Dugan, 530 E Central Blvd #1501, Orlando, FL, 32801, US

(21) Appl. No.: 12/396,465

(22) Filed: Mar. 2, 2009

Related U.S. Application Data
(60) Provisional application No. 61/032,083, filed on Feb. 28, 2008.

(51) Int. Cl. G06Q 30/00; G06Q 10/00

(52) U.S. Cl. 705/14.43; 705/14.55; 705/14.64

(57) ABSTRACT

An instant interactive dynamic software system comprised of a computer site and a mobile site serving as a central platform where businesses can upload full color advertisements with complete descriptions of any offers, click-to-call, web-links, and video ads, featuring bar coded e-coupons that consumers can access on their interne enabled mobile devices, redeem at the point of purchase at the businesses for instant savings and earn loyalty points for use. Advertisers see real-time results and can edit offers instantly. The system is designed for local market through complete global advertising campaigns. While other mobile advertising sites are available, none offer a complete system of third party instant posting of ads with the barcodes to one site, making real-time changes anytime, instantly, being able to be seen and redeemed by anyone with an internet enabled mobile device locally or globally, and having the analytics instantly available to the advertiser.

PipPops is an instant interactive software system offered on a central mobile website, combined with a computer site for businesses to upload coded discount electronic coupons and for shoppers, while mobile (on the go) using their web-enabled mobile phones, to view, select preferred offers, and redeem them for instant savings at the participating business advertisers' point of purchase with an electronic coupon.

Advertisers can monitor all data, including views and redemptions, locations and times, relative to their particular coupon campaigns and can edit, delete, expand coverage, or add additional campaigns, instantly, at any time, in real-time.

An additional aim and very important most critical benefit of this system is the economic and environmental savings inherent in lessening the impact of printing and mailing paper coupons, fliers, and cataLOGS. Truly, the greatest benefit for all areas of consideration with respect to cost, savings, value, and environmental significance while creating a completely different method of conducting business with retailers online while mobile.

Simply put, it is the first instant interactive mobile e-coupon system available to anyone using a web-enabled mobile device to view offers posted by businesses on a central mobile site, that can be posted by the advertisers instantly (rather than having to submit the ads to a company for creation and then wait for publication) for viewing anywhere at any time, setting parameters for specific local ads to complete global exposure and allowing the users to see the advertisement with the capability of redeeming a preferred offer at the point of purchase at the participating business for instant savings. While all of this is going on, the business receives instant analytics from the registered users specific to their campaign, an instant benefit for the business.

Although other types of mobile coupon sites have been developed over the last few years, there are very distinct differences in platform, capabilities, and features of the PipPops system that are discussed in greater detail below.

Some of the foremost distinguishing differences are the instant creation, posting, and interactive capabilities, including creative functions, open to the businesses choosing to advertise, allowing instant viewing by the users enabling instant participation with real-time analytics viewable to the advertisers for instant review. The easy user accessibility only requires an internet-enabled mobile device and requires no software downloads.

The system is available on internet-accessible computers and mobile devices and, at its most basic, could be compared to an interactive entertainment type discount book with bar coded coupons available on a mobile device for use at the point of sale, and, it can be changed instantly, is paperless, and is always with everybody who uses a web-enabled mobile device.

The basic functions allow businesses to post their own ad offers (individual offers that are not businesses, e.g., someone wishing to sell an antique chair, are capable of being used, also), change them at any time, in real-time, and place them in local areas to global areas for viewing and redemption by consumers on the go. These offers can contain any type of coding the advertiser chooses—a bar code, alphanumeric, 3-D matrix, and many other advanced technology, such as a web link, click-to-call, video and more that is available, etc., and offer the advertiser the option of uploading full-color images and various links ranging from typical web site links, to click-to-call, to videos.

Users are required to register the first time to use the system providing valuable data that is captured for advertiser conducting the campaign. The data is generic and varies according to the uses' desires of participation and value desire for that participation. You're a user and want to give a little more information, you get a little more incentive in the way of rewards. You give us instant news from your local area, you're going to get greater instant rewards.

This is a voluntary system with the participants desiring to have all of the information as to what's available tonight, but it begins with a great instant e-coupon program. You get money for nothing and your . . . well, something else for free if your want to play the game. What we're talking here is something beyond money, or just saving money. The advertisers want more customers, we all want to save money, and if we can find something that gives us something better than the actual value of the money, we're there. If you can use a coupon to get a two for one offer, you are using something that is more valuable than just walking in and paying the money with out the “two for one,” plus if you're getting extra value in the way of points or loyalty points or something extra, you're probably going to, at least, consider it.

Does that e-coupon create a situation where you have created a value added situation for your money?

Of course—anytime you can get something for nothing, you have increased the value of your spending dollar and why wouldn't you always want to do that?

And, then, the advertiser—he's a key component. If they're not getting anything for their investment they're not going to be there which means the users aren't going to be there which means—well, less deals more costs.

While it is generic data such as gender, age group, home zip codes and the like provided in totality within the PipPops system, it does provide the advertiser with key information for the advertiser as to the demographics in which the advertising campaign is being conducted and the respective activity with respect to that campaign. Is there any importance to this added data?

The great question in mobile marketing today is how do we make money doing this. It doesn't matter whether we're talking about MySpace, Facebook, Twitter, but how does all of this get monetized? How. do you get people to pay for ads on your site?

Well, PipPops is ads. It's all money. It's all preference.

Users can choose to upgrade their membership to receive increasing incentives by providing additional requested data. Their identities are safeguarded with the advertisers only receiving generic, but important data for their advertising campaigns, nevertheless.

The system is actually comprised of two websites; one accessible on a computer, the other accessible on any web-enabled mobile device. The difference being that it requires the use of a mobile device by the consumer in order to redeem the offers to save money while on the go. The computer site provides a coordinated calendar of events and the analytics of the demographic and the information as to who, what, where, when, and how the coupon was viewed, referred, rated and redeemed.

The following are functions, capabilities and components of the system: choosing a default or alternative location to show all e-coupons at all times for that location, searching the site using a built in search engine, browsing coupons on either the computer site or the mobile site, a social component where users can have profiles that can be browsed, add coupons or companies as favorites, be alerted by choice whenever new coupons are added, subscribe to another user's favorites list (“friend them”), and import their friend lists from MySpace Facebook, Gmail, Hotmail, etc., to see if anyone they know is on the service,

Rating and Reviewing—users can rate a coupon or a company from 1-5 stars, submit reviews of any company and coupon, coupons can be ranked by popularity (“Top 10 offers”), and companies can be ranked by popularity.

SMS/text messaging—coupons can be sent via SMS/text message to users who have opted in to this service.

Users can send SMS messages to other users.

Related coupon functionality—the system makes coupon and retailer and company suggestions to the users based on past purchases.

Points and Rewards system—users earn points through redeeming coupons, posting insightful comments, and referring new users to the service. These points can be redeemed for prizes, VIP coupons, free SMS messages, gifts, or cash payouts.

A credit system where users gain credits for providing additional personal information to the system, referring other users, redeeming a certain amount of coupons in a specific amount of time to win contests or numerous other uses. Credits can then be exchanged for cash, prizes or special coupons with better offers.

Paying bills and using the system for the mobile purchasing or exchange of tickets for movies, sporting events, theater, etc.

Multi-Level Marketing Reseller Program (2-level multi-level marketing system), where users can refer new advertisers and receive a recurring percentage of any money spent at the site. Users who refer other users who then refer advertisers can receive a smaller percentage of any money spent. This creates a system where users can be actively selling the service and earning money.

Location awareness (what's around me?)—users can see all of the businesses offering the e-coupons close to them.

The system provides the ability for users to post their own sites for personal use as the advertisers have their own sites for advertising/branding use.

Features for the Advertisers: Choose cities and/or states to display offers in from a list of checkboxes featuring a zip code/radius feature.

Automatically post new coupons to various web-based services for integration such as Google Shopping, Craigslist, and eBay.

Filter analytic reports on multiple criteria (i.e., a graph showing coupon redemption age group IN city ON day).

Upload click-to-call, website links, and videos.

Create and edit adverts from a computer or mobile device, view their analytics anytime, in real-time and the ability translate the rich and mobile sites into an alternative language (Spanish, for example).

Additional Features and Components for both Users and Advertisers: A commenting component—users can add comments to coupons or companies and companies can choose to moderate comments attached to themselves or their coupons.

RSS feeds for coupons, companies and user favorites to see any updates made on the site.

QR code interactive capability—mobile tagging

A community blog, a company blog, and an advertisers' blog.

Video guides—for advertisers to help them get signed up and also provides a video introduction for users and a separate introduction for advertisers.

An interactive calendar of events for users and advertisers to contribute events and business listings in real-time.

An interactive directory with the ability for advertisers and users to contribute events to which coupons can be attached.

Paying—auto-billing via PayPal or other credit card or payment methods for advertisers to purchase the ability to post advertisements for a period of time instantly.

Additional Component for Users, Advertisers, and PipPops—A cash back rewards program as a reseller with a company, say, like Walmart.

A members-only website where users can sign in and see a list of products sold by a company, say, like Walmart.

If they click on a product it takes them to a company, say, like Walmart's website with our affiliate ID attached.

The user purchases the product and we get a small commission (typically 2-3%).

We have the option of crediting the user with part of the commission as a “cash back reward” (around 1-2% of the purchase price).

We can keep the leftover affiliate commission, or pass on another smaller part of the commission to the user who referred the purchasing user (multi-level marketing)

An economic and environmental savings inherent in lessening the impact of printing and mailing coupons, fliers, and cataLOGs. Less Paper, Saves Trees, More Savings to the Advertisers and the Users.

### DESCRIPTION

### Field of the Invention

First of all, we're talking about online. We're talking about online advertising and we're talking about online computer marketing, but we're also talking about online mobile advertising. Mobile marketing. There's a difference—mobile advertising is considered to be a part of mobile marketing. It's a brand new field. Most companies that have gotten involved have tried a number of different things from “social” sites to retail sites. Currently, that can be described as the two ends of the spectrum with respect to mobile marketing and there is much discrepancy in the definitions, functions, and reality of mobile marketing. In many circles, most agree that it has a great potential, but a long way to go.

Now, we can generalize and say we're in this broad category and it would be mobile marketing and more specifically, mobile online advertising, but we believe this invention creates a new category.

That's part of what we claim. There isn't a category for us. So, we claim:

We're talking about online on mobile devices providing an interactive application. That's the field. However, we're also not just talking about talking on mobile devices. We're talking about mobile devices that are web-enabled. IPhone, Blackberry, Voyager, Storm, to name a few—the smartphones as they're currently referred to. In any case, any mobile device that can access the Internet (World Wide Web).

The present invention relates to the relatively new field of mobile electronic coupons (e-coupons) but, more specifically, a new field that we've initialized—instant interactive mobile online advertising creation by a third-party (e.g., business advertiser) using the program to post an e-coupon or other type of offer to a central mobile site, available for instant viewing and use (selection of the preferred e-coupons for redemption and instant savings at the advertisers' point of purchase at the business) by anyone using a web-accessible mobile device, while providing instant analytical data about the registered users of the program to the third-party (e.g., business entity).

The reason we specify a “new field that we've created” is that there are platforms that allow for e-coupon creation by the platform service company. It takes time, it is not instant, nor available to the advertiser to instantly upload the offers as the codes to upload and change the site have to be changed by those companies that are the platform providers for the advertisers' ads to appear. Even if the advertisers were computer programmers, the few companies involved in the new industry aren't going to give up their software codes to anyone to just manipulate their sites in any way.

Additionally, the advertisers have to wait for any results of the analytics, not a positive for the advertiser. Time is of the essence with respect to information, more especially now.

All data are available instantly on our system.

If you look at the “field of online advertising” and, then, move to the next field, “mobile” online advertising, we have initiated a new field, “instant interactive mobile online advertising with an additional step, that being, that we've created a system for anyone to post their own ads on an interactive mobile online site that appear on the site instantly when posted and then through the program allow the posters the capability of monitoring any and all activity on that posting by registered users of the system—in-real-time while the users have the benefit of savings at the point of purchase at the advertiser's place of business. This is all complemented by the interactive calendar of events on the rich site containing many features.

### BACKGROUND OF THE INVENTION

Today, there exist many techniques for the distribution of electronic (e-coupons) to potential customers. A seller of a service of product can distribute mass email messages with e-coupons attached to or within the message. The seller then hopes that at least some of the potential customers who receive the messages will redeem the e-coupons included. Additionally, a seller can post an e-coupon on a website, whether or not owned by the seller, and hope that a potential customer will see the e-coupon and choose to redeem it. Similar techniques exist for targeted distribution of coupons to attract potential customers who live local to a seller. For example, local restaurants or stores can attempt to attract customers on web pages local to a particular city or attempt to operate a SMS/text messaging marketing campaign, targeting cell phone users. City newspapers may have a website and these local sellers can post e-coupons on the site with the same hope of a customer seeing the e-coupon and choosing to redeem it. In most cases, it requires a lot of time and search to determine who's offering what and when and in the best case scenario a limited selection of actual bar coded e-coupons available to be sent to or accessed by the customers' mobile device.

A need exists for the advertisers to be able get their offers to the potential customers as fast as they can; instantly, if possible. And they need to be in control, not have to wait two weeks while some programmer changes the code or some printer gears up and prints the magazines. They need to be able to communicate in some instant method about what they're offering and when. Consumers on the other hand, having the preference of knowing or not knowing, prefer the knowledge and the option of making the choice at their time and place and it's certainly fun knowing it about it NOW versus THEN.

PipPops is simply about pushing a button on your mobile, accessing the site, and going to the category that you need to save money NOW. Heading to Home Depot? Maybe they have an additional $10 savings on your purchase. Are you not going to use it? Time for lunch? Let's look under FOOD and see who has the best two for one offer today. Oh, TGI Friday's has a two for one for today's lunch, only. It's only a matter of going there and clicking the button on your mobile and you just saved money.

And, TGI Friday's can change the dinner special on their own, anytime from anywhere. They don't need us or Google or Yahoo or CNN or whomever to change it for them. They make the instant changes at their leisure; control their entire campaigns, whether in one zip code or globally. The consumer's benefit by being up-to-date about every offer in their area at one mobile location.

### Field of the Invention

### Coupons

A coupon is a ticket or a document that can be exchanged for a financial discount, a rebate, or other similar benefits when purchasing a product. Some tickets are used, for example, for getting in to see the opera, the baseball game, or the latest movie. Some coupons are used simply as an incentive or inducement to get added value by either causing increased interest or a continuum of an accrued savings.

Coupons have largely been used by manufacturers of consumer-packaged goods, as well as by retailers for use in retail stores. Paper coupons are still the most popular form of coupons, and are distributed through mail, newspapers, magazine, or other means.

A large number of public and private companies use paper coupons as a marketing instrument in the United States (further comments on the global market follow later). However, according a research firm, retailers and consumer product goods (CPG) companies spend an estimated $7 billion each year on the print and distribution of coupons (not including the value of the discounts). As a result, it becomes difficult to justify large-scale investments in paper coupons.

### Online Coupons

The Internet enabled the first-ever mass-scale digital distribution of coupons. The coupons could be distributed cost effectively through different electronic channels, including e-mail, click-able advertisements, give-always, and others. Increasing multimedia capabilities also meant that branding would become a feature in online coupons campaigns. Some specialized websites offer web storefronts for coupon advertising and distribution.

### Mobile Coupons

Mobile coupons are the next step in the evolution of the coupon industry. They present new opportunities for the mass distribution of promotional messages to a large number of consumers. Some of the drivers of mobile coupon solutions are as follows:

Solving the portability problem of paper and Internet coupons—consumers always have their mobile phones with them

Presentation of relevant, personalized offers to consumers

Extremely low cost of campaign

Pervasiveness of text messaging

Some possible implementations of mobile coupons solutions are as follows:

Unique numerical coupon codes downloaded and managed by dedicated applications on mobile handsets.

Barcodes downloaded to the handset in different formats and read at the POS by capable readers. Interestingly, the reader itself could be a camera-equipped mobile phone.

Special numbers or UPCs downloaded to the handset and redeemed by the visual or electronic confirmation of the coupon code.

Directional coupons—these are special uniform resource locators (URLs) embedded in barcodes, distributed either in print or available on the packaging of products. They are scanned by camera-equipped mobile phones that also have a software client to decode the information. The URL is then used by the web browser in the mobile phone to establish a connection to a relevant website (or to the premium mobile content itself, if available at a discount).

The use of near field communications (NFC) RFID chips in a phone, so that promotion coupon can be “read” by the phone and then used at the store. This is not expected to happen until retailers install NFC readers in retail outlets.

One of the most significant challenges for barcode-based mobile coupons solutions is the implementation of new scanning hardware at the retail POS. Such hardware is expensive to install; moreover, the lack of volume has not yet been able to justify the investments in such solutions. This has been a major cause of the limited adoption of mobile coupons at the retail POS. Successful mobile coupons solutions should require little or no change at the retail end for maximum adoption.

### BRIEF SUMMARY OF THE INVENTION—IT'S A SYSTEM

### PipPops Overview—The Giant Leap for Mankind

PipPops—Partners In Profit Point Of Purchase Savings Systems is an interactive software system available at http://www.GripOffs.mobi on a web-enabled mobile device and http://www.GripOffs.com on a computer, that was specifically created as a central platform on which businesses can engage with consumers through an online system and for businesses to upload their own e-coupons (electronic coupons we presently call “GripOffs”) including bar codes, and to control entire ad campaigns from start to finish, all the while being able to monitor all activities and gather key data (who, what, where, when, why, and how) about who's looking at their own ads and redeeming them in REAL-TIME, allowing not only for creation, but modification of the ad campaign, editing, behavioral modification (e.g., “hey users, check back with us at Noon everyday as we have a new daily offer”), and have available to them the ability to see these actual results, all in REAL-TIME. You can't get any faster than RIGHT NOW. There are no software downloads required by either the Advertisers or the Users; everyone uses their mobile device and goes to http://www.GripOffs.mobi/.

Using a mobile website, htto://www.GrioOffs.mobi/, as a central clearinghouse location for the mobile e-coupon offers—with bar and/or other codes and able to be redeemed at the point of purchase—yields instant savings for the user and additional business for the advertiser.

Not only additional business for the advertiser, but also additional real-time data for the advertiser to use to improve his current and future advertising campaigns and much more. The analytics provide a clear record of who, what, where, when, why, and how, and, combined with the complete system, the business is able to create a new environment; whereas the user, previously referred to as “customer,” becomes a participant in the program.

PipPops is a unique system that could be represented by a six-sided cube.

Each side of the cube represents an integral part of the system.

Side 1=Advertisers: Retail Merchants, Banks, Restaurants, Sporting Ventures, Amusement and Entertainment Providers, Consumer, Legal & Professional Services, etc.

Side 2=Users: Shoppers, sports enthusiasts, adventurisms, people seeking entertainment, Consumers of Retail, financial, professional and entertainment services, anyone looking for a bargain, what's available where they presently are, etc.

Side 3=PipPops Websites: Currently http://www.GripOffs.mobi/ and http://www.GripOffs.com, accessed via mobile device or computer with their complete functions and capabilities.

Side 4=e-Coupons: With all capabilities (bar codes, click-to-call, video, website and other link capabilities)

Side 5=Loyalty point/credit/commission/and other reward activities:—Loyalty card similar to credit card, because it will actually be a credit card for the premium or club members only, used for redeeming points/credits, etc. for merchandise/cash/rewards.

Side 6=Data: Stored and on-going instantly-available analytical user-demographics currently legal, requested by and available to advertisers including gender, age bracket, zip codes, ethnicity, as submitted voluntarily by the Users.

This site was developed as a mobile web application rather than a custom Java applet, reducing the costs, shortening the development time, reducing future maintenance requirements, and is in line with and exceeds current industry trends, which are moving towards a simple, mobile-optimized site separate from an organization's main website to which mobile users are redirected.

The PipPops system provides most of all of the same functionalities as other software using Java applications, but, at the same time, makes a giant leap forward by providing instant mobile functionality not available on others—real time third party uploading, viewing, redemption, and data gathering combined with instant user access via web accessible mobile devices, for viewing and use at the point of purchase, with bar coded coupon redemption functions and other methods of doing business whether click to call, links, videos and more.

This is an area where we deviated from the norm by using a more modern mobile web front-end to the site when accessing it from a handset, rather than using a Java application.

Some really important advantages to our system:

Everyone benefits: the user, the merchants and the environment by reducing mailbox clutter, and the amount of time spent sifting through unwanted mailers, printed coupons or printing coupons off of Internet sites.

Users' participation benefits merchants by lowering their cost of distribution and helping them better target their market.

Users' and Advertisers' participation will collectively make a huge positive impact on our environment; as partners, we reduce the energy consumed, the carbon emissions, and the lost forests resulting from the current annual production and discarding of more than 19 billion paper catalogs, print coupons and advertising, and printed coupons from the Internet.

### IN SUMMARY

What I claim as my invention is an interactive, instant system, operating on a website, accessed by mobile devices (a mobile website) featuring a dynamic real-time software program that allows businesses to create coupons or other types of advertising or offers and then analyze, improve upon, edit, delete, duplicate in multiple geographic areas, or change, at will, their own mobile coupons, uploading them to the site, instantly visible to the mobile public.

The advertiser has the advantage of being able to monitor the real-time data when users go to the site, analyzing the activity to see how to improve upon the campaign, editing and/or duplicating it in multiple geographic areas, if desired, but, in any case, generally conducting instant business, learning much more quickly—at their instant discretion—and, seeing, for a fact, what the users prefer, because the advertiser is made aware of when the user views and when the user chooses to redeem the advertiser's coupon offer at the point of purchase, where the majority of the buying decisions are made, when the user is in “shopping mode,” the advertiser sees it all, as to who, what, where, when, why, and how.

The fact of the matter is, ever since advertising began, the advertiser wanted as much information as he could get as fast as he could get it. This is as much information as he can get as fast as he can get it. There's nothing faster than RIGHT NOW.

The registered user saves money time and time again. The mobile users get to use the site for free to access and use discount coupons and offers all with coding from numerous advertisers all located on one site, all with bar codes or coding to be used at the point of purchase; all available at the website accessible on the mobile user's mobile device.

In order to redeem the coupons at the point of purchase for discounts, savings, points, contests, or whatever, the user must first register, said registration requiring various generic and personal data, including, but not limited to, gender, age, ethnicity, and location.

Once a user has registered, she/he simply logs in and the real-time software will show the location and time of the coupon viewing and/or redemption by that user, providing the advertiser with instant data to analyze, improve upon, edit, delete, duplicate in multiple geographic areas, and, generally, conduct instant business, learning much quicker and, for a fact, what the users prefer, improving the success of the marketing campaign, while saving money for the users who have a preference for the advertiser's offer, and accumulating points for the users for future savings and offers by simply using their mobile devices to go to the central mobile website where they are able to view all advertisers' offers in the area in which they presently are in or intend to go to.

Example: Mary and Joan have decided to meet for lunch. Joan, a registered user of GripOffs, logs onto the site using her mobile phone. She clicks on “Restaurants” and sees that her favorite Bistro is offering a 2 for 1 lunch special good for today. She calls her friend Mary to suggest they meet there, and, after lunch, Joan simply clicks on the coupon and shows her mobile phone to the cashier when paying the bill to redeem the coupon and receive the special savings offered by the restaurant. The advertiser gets more business. The advertiser sees who, what, where, and when the users viewed and redeemed the coupon in real-time. The users save money. Paperless, convenient, easy-to-use, always with you.

Hence: Partners In Profit Point Of Purchase Savings System.

The computer (rich) site is available to check the calendar of events in addition to the blogs, instructions, upgrades, etc.

### DETAILED DESCRIPTION OF THE INVENTION

### Layout for Mobile Website

The site was originally built using industry-standard open-source tools such as PHP and MySQL. As technology changes, upgrades will be utilized.

The site is completely self-contained and any technical knowledge to perform day-to-day administration on the site is not required on the part of the advertisers or users.

The main website allows three kinds of users to log in: administrators (staff of PipPops), who are able to alter user and advertiser accounts, update edit or delete advertisements, change the site, etc; advertisers, who can list coupons with parameters, i.e., how many are available for redemption per user, zip codes in which the coupons are valid (particularly useful for global and national companies and chains), etc.; and, finally, the end user—the customer at the point of purchase. Initially, they register to use the system and, then, after that, just log in.

Although the advertiser is able to access and control their own campaign ads, when they sign up to be an advertiser they agree to ethical, legal and appropriate use of the site, and any infractions of law or common decency can deny their continued use of the site. The administrators can oversee, restrict or remove their usage.

We are able to take automatic payment at this site for the advertising fees from the businesses and automate the process for them. Advertisers can also see analytic data for their campaigns (e.g., how many coupons are viewed and when, how many are redeemed, and, as we ask the users for demographic information when they sign up, we can break down a campaign's response by those demographics—age, location, gender, etc., providing that information in real-time to the advertisers.

In addition to the ability to place their own ads, logos, links and videos, advertisers may choose to utilize PipPops' marketing expertise and design consultants to design, upload, and edit campaigns and ads for additional fees.

### Site Design

The goal was to develop a system to be accessed at a mobile website which allowed users to redeem electronic coupons at businesses in their area from their wireless handset, while, at the same time, allow advertisers to post coupons to be redeemed using a mobile phone and to see all data when and where it happens in real-time, reducing need and use of paper coupons, and offering the public and businesses a way to operate together as partners in the profit at the actual point of purchase (users save money, advertisers get more business), when and where most final choices are made.

Two sites were developed which share one common database—one full website designed to be able to be accessed from the user's computer browser (the “rich” site) and a mobile site which can be accessed from a user's wireless handset (the “mobile” site).

### The Rich Site

### Static Pages

There is a static pages set containing the site's Privacy Policy, a Sitemap, Help with using the site, an About page, a Press page containing press releases and other marketing information and a Contact Us page to e-mail the owner or webmaster of the site.

### Browse Coupon Catalog

All visitors to the site, whether registered or anonymous, are able to browse a list of coupons available on the site. However, unregistered users will not be able to redeem coupons—just directed to instructions on how to register and access the site via their mobile handset.

### User Registration

The registration process gathers basic information from each new user:

User name

E-Mail Address

Mobile Device Phone Number

Zip Code

Password

A drop-down box allows users to say how they found the site, or to fill in an “Other” box if their reason is not one of the defaults.

Optionally, users are able to specify more detailed information such as address, gender, ethnicity and age group.

This signup process handles initial user or advertiser signups automatically.

Zip Code/Radius/GPS

Data base allowing advertisers to control specific areas for viewing of their offers while users see the offers in the geographic area in which they are either located or select.

### User Dashboard

When a user logs in, they will be able to view and edit their personal details and account settings. They will also be able to view a list of coupons they have previously redeemed along with the dates of redemption.

By tracking prior redemptions of coupons, advertisers can also set limitations on repeated use (e.g., “one per customer”).

User accounts that have been set as Advertisers will be able to add new coupons into the system by entering:

All items to be uploaded, such as,

The company the coupon is for

The category of the offer

A title for the offer

A full-color image for the offer

A detailed description of the offer

Location of the business

Contact information for the business

A click-to-call the business link

A website link

A video upload link

A unique numeric serial number or barcode for the offer (for cashier use when redeeming)

Any limitations inherent in the redemption

A numeric limit to the number of times a user can redeem a coupon

A start date for the offer

An expiration date for the offer

Advertisers are able to list all coupons they have entered into the system and see which offers are active and which are expired.

By clicking on an offer an advertiser is able to see extensive analytical reports consisting of charts and tables detailing any activity up to the redemption rate for their offer by:

A list of zip codes, a list of cities, a list of states or an “everywhere” option so that they may restrict the offer to only be shown to users in a particular area.

Geographic Location (city, state, zip)

Time, date and location of redemption

Redemption by Age Group

Redemption by Gender

Redemption by Ethnicity

Users who have not specified the last three details when signing up will by marked as “Data Unavailable” in the final three charts.

Administration Dashboard

Administrators of the site have complete control and are able to view, modify and delete any articles, users, coupons or data on the site. This will be a secure area where administrators can:
Create, Read, Update and Delete (in the industry this gets the charming acronym “CRUD”) all:
   Articles
   Users
   Coupons
   Data

Send E-mail to any user or advertiser

Send SMS/text messages to any user or advertiser

Contact any user or advertiser by mobile device phone number

Reset the password of any user or advertiser

Temporarily block users or advertisers who are abusive or disruptive

### The Mobile Site

The mobile site is written in basic standards-compliant XHTML with static images and optimized for viewing on small screen, low bandwidth wireless devices.

If a user attempts to visit the mobile site using their PC the site will automatically detect this and redirect them back to the rich site.

### Landing Page

The front page of the site contains basic site navigation, search, login and register links. It shows a list of the most recently added coupons and the most popular coupons along with the top-level categories of the coupon directory (“Food”, “Travel”, “Entertainment”, etc.) along with the number of coupons in that category.

### Static Pages

There is a static pages set containing the site's Privacy Policy, a Sitemap, Help with using the site, an About page, a Press page containing press releases and other marketing information and a Contact Us page to e-mail the owner or webmaster of the site. Content for these pages is taken from the same source as the static pages on the rich site, just displayed on a page suitable for mobile users to read.

### Browse Coupon Catalog

All visitors to the site, whether registered or anonymous, are able to browse a list of coupons available on the site by category and click a button to review them.

Users are also able to search the coupon directory by keyword, zip code, city or state.

### Coupon Redemption

When a user has browsed to a coupon they like they can click a link to redeem the coupon. If a user is logged on then they will be asked if they are ready to redeem the coupon (i.e., if they are standing in front of the cashier at that moment and ready to buy). If the user confirms with a “yes” answer they will be shown the unique code attached to the coupon with an automatically generated barcode above it. The cashier can then scan the user's mobile screen with a barcode scanner or enter the unique code manually.

Once the user has gone through the confirmation process, the system will note that the user has redeemed one coupon and any attempts to redeem more than the advertiser-set limit to number of coupons per person will fail.

If the user clicks “No” when they are asked if they are standing in front of the cashier and ready to purchase they will be taken to a screen which contains a short passage telling them how to redeem the coupon (i.e., “when you have the product in hand and you're in front of the cashier, click ‘Redeem’ and you'll be given a code. Show the cashier your phone and they'll do the rest”) along with a “Retry” button (in case they're in the store, just not ready to redeem yet) and a “Return to Coupon List” button.

### Zip Code

Data base allowing advertisers to control specific areas for viewing of their offers while users see the offers in the geographic area in which they are located or intend to go to.

### User Dashboard

When a user logs in, they are able to view and edit their personal details and account settings. They are also able to view a list of coupons they have previously redeemed along with the date of redemption. By tracking prior redemptions of coupons we can also set limitations on repeated use (e.g., “one per customer”).

### Site Maps

Rich Site Map

Registered Users Advertisers

Privacy Help Sitemap Browse

Search

Coupons

Coupon

Profile

Register Login About Contact

Account

Settings

View

Redeemed

Create New

Coupon

View Coupon

Analytics

Dashboard

Press

Landing Page

Mobile Site Map

1. PipPops is a completely self-contained self-service mobile e-coupon software system using industry-standard open-source tools such as PHP and MySQL, and written in basic standards-compliant XHTML with static images and optimized for viewing on small screen, low bandwidth wireless devices as well as all future web-enabled mobile devices, provided as a mobile website platform for business owners, independent of the PipPops company, to create and instantly upload unique electronic coded e-commerce discount coupons and advertisements, including, but not limited to full-color images, click-to-call, web-links, and/or videos instantly, in real-time, for the immediate viewing and use by potential customers with web-enabled mobile devices. Each advertiser has the ability to create, post, edit and set parameters in real-time.

2. Users of web-enabled mobile devices are able to access the designated PipPops mobile site, at any time, to peruse advertising offers by their geographic default location or other geographic choice which they may specify, and by criteria which they select by first clicking on general categories, such as type of establishment, (i.e. restaurant) and then specific sub-categories (eg., Italian, French; barber, Spa; Attorney, Dentist; shoes, etc.) that have been placed by the participating business advertisers. The users have the ability to view all current offers, watch the advertisers' videos, click-to-call, or click to redeem a particular offer and present it at the participating business at the point of purchase for instant savings, within the parameters of the offer. At the register, the business personnel either read the alpha-numeric code on the mobile e-coupon or scan the visible electronic (e.g., bar) code at the time of purchase. The codes are created by the advertiser and can be edited at any time.

3. This mobile interactive e-commerce software system automatically tracks, collects, and compiles demographic information (i.e., zip code location, age, gender, etc., as provided at time of registration) of the anonymous users each time a specific offer is viewed and each time an offer is clicked to redeem, so that the business owner has, for the first time, the unique ability to enter the interactive computer dashboard site and view, at any time they wish, the instant, real-time analytics of the anonymous shoppers' date/time stamp access, views and redemptions of their electronic e-coupons and offers, providing a previously unavailable real-time measure of the results of their advertising efforts, instantly, and allowing the business owner to make adjustments, at any time, instantly to their advertising campaigns.
